(19) United States
(12) Patent Application Publication
(10) Pub. No.: US 2007/0193017 A1
(43) Pub. Date: Aug. 23, 2007

(54) Hollowed, deformable, raised face bolt-ring and method of use

(76) Inventor: Harvey E. Svetlik, Grand Prairie, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/716,819

(22) Filed: Mar. 12, 2007

Related U.S. Application Data
(63) Continuation-in-part of application No. 11/229,914, filed on Sep. 19, 2005.

(51) Int. Cl. B23P 11/00

(52) U.S. Cl. 29/525.01; 29/525.02

(57) ABSTRACT

A bolt-ring pipe connector system for connecting thermoplastic (HDPE) stub end pipe is shown. The bolt-ring has an outer vertical rim portion, an inner vertical rim portion and an interconnecting web portion provided with spaced bolt holes. The top side of the bolt-ring has a beveled and angular top surface. The bottom side of the bolt-ring has a contoured recess that provides a variable cross sectional diameter. The application of bolt torque within a predetermined range compensates for visco-elastic cold flow of HDPE over time, and maintains a minimum threshold sealing stress.

### BACKGROUND OF THE INVENTION

1. Cross Reference to Related Applications

The present application is a continuation-in-part of earlier filed application Ser. No. 11/229,914, filed Sep. 19, 2005, also by the Applicant, entitled “Hollowed, Deformable, Raised Face Bolt-Ring.”

2. Field of the Invention

The present invention relates generally to pipe connector systems which utilize a bolt-ring for the field connection of pipes having a stub end, the bolt-ring being particularly adapted for the interconnection of polyolefin (HDPE) pipe. The present invention also provides an improved installation method for forming a connection between a pair of oppositely arranged stub end thermoplastic pipes using the bolt-ring.

3. Description of the Prior Art

There are a variety of pipe coupling and connector systems known in the prior art. Many of the prior art connectors were designed primarily for use in metal (iron or steel) piping systems. Typical applications included such areas as municipal water and sewage systems, chemical and petrochemical pipelines, and the like. Many of these piping systems employed solid metal flange coupling or connector rings. While these connectors worked satisfactorily in many instances, they were more expensive to produce because they were formed as solid metal rings. More recently, the so-called “convoluted” flange connectors have been introduced into the iron and steel pipeline industries. A convoluted flange utilizes a design in which an annular flange member has a U-shaped cross section to provide strength to the flange, which is reduced in weight and material content with resultant cost savings.

For example, U.S. Pat. No. 5,413,389 issued May 9, 1995 and entitled, “Cast Convoluted Piping Flange” describes a piping flange having a convoluted design with a transition in thickness from an outer rim to an inner rim of the flange so as to provide for stress management throughout the cross-sectional geometry. The convoluted design purports to provide the rigidity or stiffness necessary to insure a uniform coupling face for uniform deformation of a gasket or seal, while minimizing the weight of the flange by eliminating unnecessary material.

U.S. Pat. No. 4,458,924 issued Jul. 10, 1984, entitled, “Bimetal Flange Connector”, describes a bimetal flange that utilizes a hub of a first metal bonded to a rim of a second metal. The concept of a composite flange of two materials and the use of a recess to reduce weight and optimize stress distribution is described. Again, this connector was designed with a metal piping system in mind.

The convoluted flanges and flange couplers of the type described in the referenced patents have been used successfully in coupling metal pipes in many instances. Furthermore, the technique of computer aided stress analysis in the design of piping flanges has led to further improvements in the configuration of flanges that address the issue of stresses transmitted to the pipe, and in the design and construction of composite material flanges for metal piping systems.

There nevertheless exists a need for improvements in pipe coupling systems where the pipes are formed from thermoplastic materials such as polyethylene or another polyolefin. A popular thermoplastic piping material is high density polyethylene (HDPE). One commercially available system for HDPE piping systems is known in the industry as the “Van-Stone Style Polyethylene Pipe Joint.” While these systems have been used successfully for a number of years, the bolt-ring was a solid ring and thus had the disadvantages of weight and cost of manufacture discussed above with respect to the metal piping systems.

There are a number of reasons why a bolt-ring connector which is developed for use with a steel or ductile iron pipe might not be suitable for use with a thermoplastic material, such as polyethylene. Polyethylene is a visco-elastic material which naturally cold-flows under stress over time. The rate of strain is in proportion to stress intensity and time. When a solid steel bolt-ring is used on an HDPE flange and the HDPE thermally expands, the HDPE flange face cold-flows, i.e., is crushed by its own expansion against an immovable, fixed and excessively stiff bolt-ring. Upon cooling, the HDPE flange has typically cold-flowed to a reduced size flange thickness such that leaks can and do occur at the coupling. Upon freezing, the HDPE flange face thins by thermal contraction, the bolt-load is lost, the seal pressure diminishes, and leaks occur. When an HDPE flanged joint is bolted together using solid-metal coupling flange and very-stiff bolt-rings, cold flow of the HDPE stub-end usually occurs fairly quickly, typically within about eight hours. As a result, the contractor will often be forced to come back to the job site the next morning to re-tighten the coupling flange.

Additionally, HDPE exhibits expansion and contraction characteristics which are on the order of ten times those of steel under similar environmental conditions. Because the thermal expansion characteristics of steel are so much less than those of polyethylene, the prior art flange gaskets of the above type have been successfully employed in steel piping systems. HDPE, on the other hand, exhibits much greater expansion and contraction characteristics and also exhibits a “softness” which is about the same as the gasket materials which are used in the steel pipe coupling systems.

It would be advantageous, therefore, to provide an improved bolt-ring for connecting stub end thermoplastic pipe which could be elastically bent by sufficient bolt-load to accommodate the initial and long term cold flow of the polyolefin pipe material.

It would also be advantageous to provide such an improved bolt-ring for thermoplastic pipe which, in the presence of cold flow, would exhibit a residual bolt-ring deformation load sufficiently high to impose a positive pressure seal for the pipe coupling under all operating conditions.

It would also be advantageous to provide a method for installing such an improved bolt-ring for thermoplastic pipe ends, wherein a specific bolt torque is applied, within a predetermined range, in order to compensate for visco-elastic cold flow of HDPE over time, thereby maintaining a minimum threshold sealing stress.

### SUMMARY OF THE INVENTION

The improved bolt-ring connector of the invention overcomes the above noted deficiencies associated with solid steel bolt-rings. The bolt-ring of the invention also provides advantages over the known commercially available “convoluted flange” connector systems. The new, deformable, variable geometry, hollowed, bolt-ring can be flexed by slight deformations under constant bolt-load. As a result, all anticipated initial and operating changes in HDPE stub-end dimensions, such as those caused by bolt-up and thermal strain, are managed by the bolt-ring. The result is a more uniform sealing pressure across wide operating circumstances of temperature, operating pressure excursions, and even water-hammer pressure surges.

The present inventive method is used for forming a connection between a pair of oppositely arranged stub end thermoplastic pipes, each having an end stub with a contact shoulder and an oppositely arranged end face. First, a pair of mating bolts rings are provided on the stub ends of the oppositely arranged pipes. Each bolt-ring comprises a bolt-ring body having an outer vertical rim portion, an inner vertical rim portion and a web portion interconnecting the outer vertical rim portion and the inner vertical rim portion. The web portion has a plurality of spaced bolt holes therein which circumscribe a centerline of the bolt-ring body.

The inner vertical rim portion, outer vertical rim portion and interconnecting web portion together form a bolting-face for each bolt-ring on a top side thereof. The top side of each bolt-ring has a beveled and angular top surface, and an opposite bottom side of each bolt-ring includes a contoured recess that reduces the material of the bolt-ring body and provides a variable cross sectional geometry. The inner vertical rim portion includes a thumb region on the bottom side of the bolt-ring which contacts the contact shoulder of the pipe end stub in use.

The first step in the method of the present invention begins by sliding the mating bolt-rings into contact on the respective stub ends of the pipe to be connected. Next, the mating bolt-rings are connected by bolting the rings together with connecting bolts. The connecting bolts pass through the spaced bolt holes provided in the web portion of each bolt-ring. The bolts are then torqued by an amount sufficient to elastically deform the mating bolt-rings and thereby create a deformation strain. The deformation strain is stored in the bolt-rings by the applied torque so as to constantly load the contact shoulders of the pair of oppositely arranged stub end thermoplastic pipes.

Preferably, each of the bolt-rings has a truncated horizontal “S” shape capable of being elastically deformed, allowing the storing of a resulting deformation strain so as to constantly load the visco-elastic contact shoulders (flange faces) of the pipe stub ends. The bolts used to connect the bolt-rings are torqued by a predetermined amount, such that after seating at a given seating stress, the respective flange face visco-elastically relaxes to a relatively high sealing stress, and that subsequent naturally occurring flexing of the “S” shape bolt-ring has sufficient distortion to overcome an expected 50 year flange face oppositely directed visco-elastic strain at a relatively lower sealing stress. The bolt torque is preferably applied within a predetermined range which compensates for visco-elastic cold flow of HDPE over time, and maintains a minimum threshold sealing stress. In other words, the bolt torque is applied in the predetermined range so that the interfacial contact stress is above a certain value for HDPE.

The applied bolt torque will vary by pipe diameter and bolt diameter in order to develop the requisite force, through bolt stretch and slight bolt-ring distortion. In the preferred embodiment of the invention, the applied bolt torque force distributed over the flange face sealing surface area develops an initial seating stress within the range of 1100 psi and 2200 psi for all HDPE pipe flange sizes.

Additional objects, features and advantages will be apparent in the written description which follows.

### BRIEF DESCRIPTION OF THE DRAWINGS

FIG. 1A is a simplified side view of a bolt-ring shown being used in the method of the invention and being slid into position on the stub end of a length of polyethylene pipe.

FIG. 1B is a view, similar to FIG. 1, but showing the bolt-ring of the invention in place on the stub end of the pipe.

FIG. 2 is an exploded view of the bolt-ring system used in the method of the invention.

FIG. 3 is a top view of the improved bolt-ring used in the method of the invention.

FIG. 4 is a bottom view of the bolt-ring of FIG. 3.

FIG. 5 is a cross sectional view of the bolt-ring used in the method of the invention taken along lines V-V in FIG. 3.

FIG. 6 is an assembly view of the bolt-ring assembly of the invention in place on the stub end of a polyethylene pipe.

FIG. 7 is a cross sectional view of the initial bolt-ring assembly of the invention in place on the stub end of a polyethylene pipe.

FIG. 8 is a cross sectional view of the view of the bolt-ring assembly of FIG. 7, after the initial compression of the HDPE flange adapter has occurred due to the bolt force of the elastically bent ring.

FIG. 9 is a cross sectional view of the view of the bolt-ring assembly of FIG. 8, once HDPE creep effect has taken place on the HDPE flange adapter and the bolt-ring has applied continuous sealing load.

### DETAILED DESCRIPTION OF THE INVENTION

As discussed briefly above, one of the commonly used prior art connecting flanges which has been used on polyethylene pipe is known in the industry as the Van-Stone style swivel bolt-ring. The standard Van-Stone style swivel bolt-rings are typically solid metal and, as a result, are very heavy. The improved bolt-ring of the present invention encompasses a hollow geometry to make the bolt-ring lighter in weight, and thus more economical for end users. The improved design of the invention eliminates the excess metal which would otherwise contribute to bolt-ring stiffness, which stiffness transfers an applied bolt-load to the sealing face of the pipe stub end contact shoulder. The bolt-ring of the invention can be conveniently cast from ductile-iron metal. This preferred cast metal bolt-ring is of variable cross-sectional geometry. It is a monolithic metal casting of variable geometry to provide predicted deformation of the bolt-ring under working load.

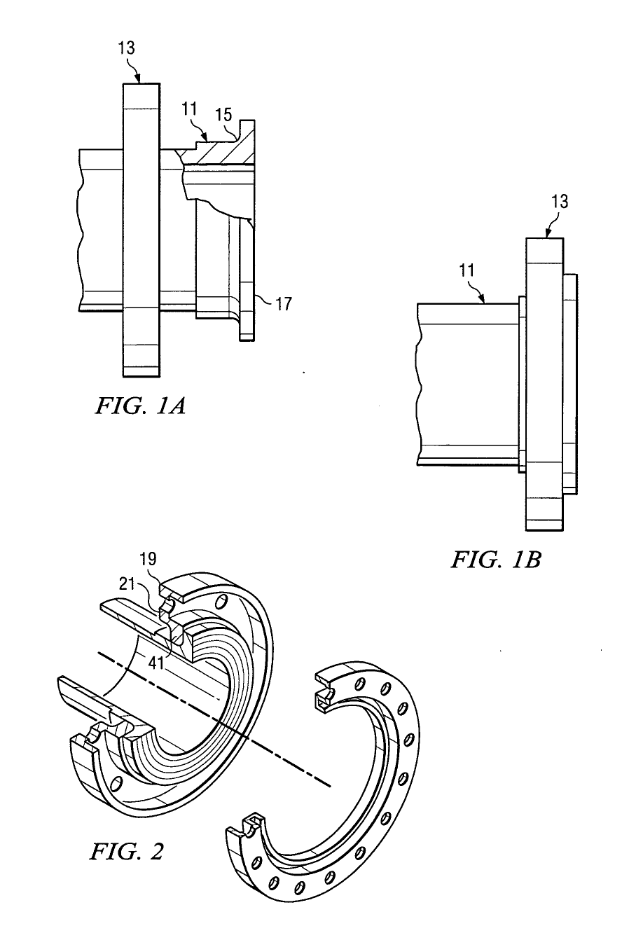

FIG. 1 is a simplified view of a polyethylene pipe lap-joint stub-end 11 onto which is fitted the bolt-ring 13 used in the method of the invention. The pipe end 11 is preferably formed of a thermoplastic material such as a suitable polyethylene, for example HDPE. The stub-end 11 has a contact shoulder 15 and an oppositely arranged end face 17. The contact shoulder and the end face are separated by a thickness that constitutes a “visco-elastic flange face.” The contact shoulder 15 forms a gasket receiving face for receiving a suitable sealing gasket. The pipe 11 might be used, for example, in a municipal or water sewage system.

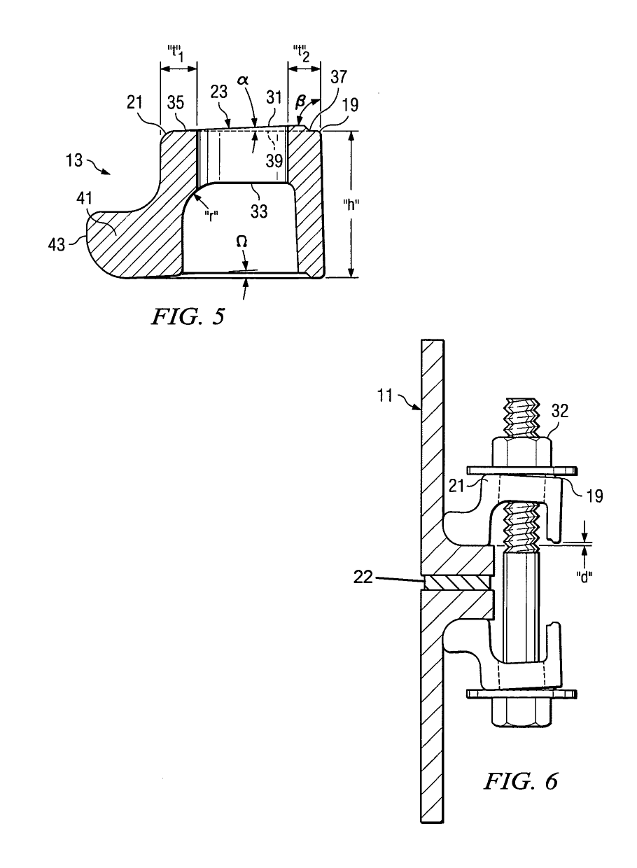

As shown in the sectional view of FIG. 5, the bolt-ring 13 has an outer vertical rim 19, an inner vertical rim 21 and a web portion 23 interconnecting the outer vertical rim portion 19 and the inner vertical portion 21. The inner and outer vertical rim portions 19, 21 are shown as being approximately equal in length in FIG. 5. In other words, the overall height “h” of the outer vertical rim 19 is approximately equal to the overall height of the inner vertical rim 21. However, in one embodiment of the invention, the overall height of the outer vertical rim 19 is specifically designed to be shorter in length than the overall height of the inner vertical rim 21. With reference to FIG. 6, the outer vertical rim 19 is shorter than the inner vertical rim 21 by the distance “d.”

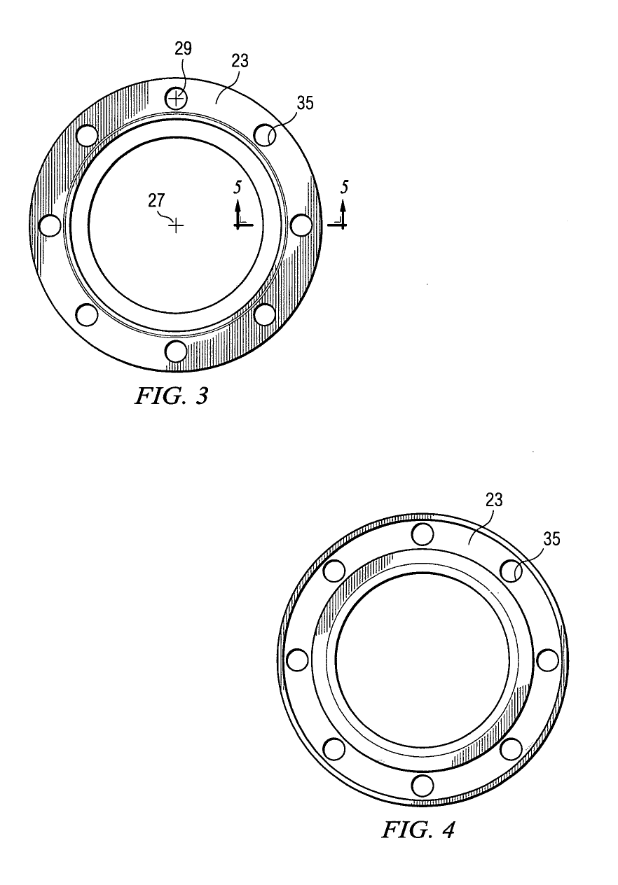

As shown in FIGS. 3 and 4, the web portion 23 has a plurality of spaced bolt holds 35 which circumscribe a centerline 27 of the bolt-ring body. Each of the bolt holes 35 provided in the interconnecting web portion 23 also has a centerline, such as centerline 39 in FIG. 3. The bolt hole centerlines 29 define a circular locus of bolt hole centerlines, indicated generally by the dotted line in FIGS. 3 and 4. In the embodiment shown in FIGS. 3 and 4, the bolt-ring body has eight evenly spaced bolt holes 35. However, the number and diameter of the holes could vary. The number of bolt-holes through the beveled top surface of the bolt-ring is in compliance with the standard number of bolts and hole diameters as specified in ASME/ANSI B16.5, ANSI B16.1, and AWWA C207 Class 150 for bolt patterns and hole diameters. The bolt-ring can be swiveled to align with other bolting components without regard for the initial alignment of the bolt holes.

As shown in FIG. 5, the inner vertical rim portion 19, the outer vertical rim portion 21 and the interconnecting web portion 23 together form a bolting-face for the bolt-ring on a top side 31 thereof. The top side 31 of the of the bolt-ring has a beveled and angular top surface. An opposite bottom side 33 of the bolt-ring includes a contoured recess that reduces the material of the bolt-ring body and provides a variable cross-sectional geometry. Applicant's design uses a sufficiently large radius adjacent to the underside of the top surface and radially outer surface of the inner vertical rim, to enable complete flow-filling, without voids, of the sand-mold cavity, during the casting of molten ductile-iron metal into the sand mold.

As shown in FIG. 5, the beveled and angular top surface 31 of the bolt-ring increases in dimension radially outward from the circular locus of the bolt hole centerlines (29 in FIG. 3) and from the centerline of the bolt-ring body (27 in FIG. 3). The beveled and angular top surface 31 can also be seen to extend between an inner joining point 35 and an outer joining point 37 on the top surface 31 of the bolt-ring. The inner vertical rim portion 21 can be seen to be perpendicular to an initial portion of the beveled and angular top surface 31 starting at about the inner joining point 35 and the outer vertical rim portion 19 can be seen to be perpendicular to the beveled and angular surface 31 at the outer joining point 37 of the top surface 31. In other words, the web portion 23 of the bolt-ring body is generally rectangular in cross section with the angular top surface 31 presenting a slight taper which increases from left to right as viewed in FIG. 5. The included angle “∝” located between the top surface 31 and an imaginary line 39 drawn in the plane of the joining points 35, 37 is approximately 2° in the embodiment of the ring shown in FIG. 5. The angle “β” in FIG. 5 is approximately 90°, giving the outer wall of the rim 19 a somewhat “inclined” aspect.

The top surface 31 becomes thicker, increasing in dimension, as the radial distance from the bolt-ring center 27 also increases. The top surface thickness transitionally increases from its inner radial portion to its outer radial portion, so as to provide spring stiffness when deformed, such that the Van-Stone lap-joint polyethylene stub-ends maintain a minimum seal load on the seal faces under all tolerable thermal-strain conditions.

The beveled and angular top surface 31 is the surface against which the connecting bolt-nut initially rests. As the nut (32 in FIG. 6) is tightened, the bolt tensile stress deforms the bolt-ring 13 so as to bring the top surface 31 flat and in parallel with the nut's bottom, and perpendicular to the axis of the bolt itself. As a result, the stress-load in compression on the interface between the nut and top-surface of the bolt-ring is uniform, i.e., there is virtually no high intensity corner or edge loading of the nut on bolt-ring top surface that could be degraded by rust over time.

The degree of the angle “∝” located between the top surface 31 and an imaginary line 39 is designed to deflect under bolt-load so as to come into virtual parallelism with the polyethylene pipe's lap-joint stub-end faces 17 so as to provide uniform and predictable load distribution on the face of the pipe stub-end; and, to be deformed by a predictable amount, such that the deformation imposes a disk “spring load” on the HDPE pipe's lap-joint stub-end, so as to accommodate the very high thermal-strain (expansion and contraction) of the polyethylene material in the stub-end face. The resulting connector assembly provides a more reliable sealing joint for a polyethylene Van-Stone style lap-joint connection because of the residual spring-load sealing force retained by the elastic deformation of the hollowed bolt-ring. Solid Van-Stone bolt-rings are more rigid and do not exhibit this spring-load effect to the same degree achieved by the present design. The improved bolt-ring used in the method of the invention provides a balance of adequate stiffness to transfer bolt-load into sealing pressure, while at the same time, providing a suitable degree of elastic deformation that maintains the polyethylene Van-Stone style lap-joint sealing face pressure above a lower threshold sealing pressure limit.

The inner rim vertical portion 21 and the outer rim vertical portion 19 are of generally constant wall thickness, indicated as “t,” and t₂” in FIG. 5, within the tolerances allowable by sand casting methods. There is a sufficiently large radius “r” (in FIG. 5) on the bolt-ring bottom side 33 and radially outer surface of the inner vertical rim portion 21 to enable complete flow filling of a sand mold during casting. The beveled and angular top surface 31 is designed to deflect under bolt-loading so as to come into parallelism with the pipe stub end faces 17 to provide uniform and predictable load distribution on the end faces 17 of the stub end 11 and to be deformed by a predictable amount, such that the deformation imposes a spring load on the pipe stub end 11.

The inner vertical rim portion 21 also includes thumb portion 41 on the bottom side of the bolt-ring which contacts the contact shoulder 15 of the pipe end stub in use 11. The integral thumb portion is cast into the lower portion of the inner vertical rim portion 21. This thumb portion does not necessarily include a “hub” as did certain of the prior art designs. In the prior art, the “hubs” were intended to enable connection and attachment of the bolt-ring to metal pipe by means of soldering, brazing or heliarc-welding. While the geometry of the thumb portion of the bolt-ring of the invention may take various forms, there is no “hub” in the prior art sense of being used for the purpose of welding, attaching, or otherwise connecting the ductile-iron bolt-ring to the OD surface of the polyethylene plastic pipe. As can be seen in FIG. 2, the thumb portion 41 of the inner vertical rim 21 of the bolt-ring is radiussed so as to conform to the curvature of the pipe stub end contact shoulder 15 to centralize and equalize a subsequently applied sealing force. The thumb portion is preferably slightly radially tapered so that, as an applied bolt-load increases, a tip 43 of the thumb portion 41 contacts the pipe stub end contact shoulder 15 proximate the pipe outer diameter.

The design of Applicant's thumb portion is significant in several respects. The “center point” of the applied bolt-load is applied closer to the inner portion of the polyethylene Van-Stone style joint such that a more even sealing pressure is impressed over a broader area providing a more uniform seal pressure over a larger area. The prior art designs allowed disk-plate rotation of the metal ring's “thumb” towards the radially outer edge of the polyethylene stub-end sealing face, such that very little sealing pressure was obtained at the ID of the sealing interface. In fact, it is known, that in many cases of the prior art designs, the Van-Stone style lap-joint had no sealing at the ID, such that the bolts had to be over tightened to force a seal at the extreme outer edge of the polyethylene stub-end sealing interface. Applicant's design constitutes a major improvement over prior art. The “thumb” of the new bolt-ring is radiussed so as to conform to the curvature of the polyethylene pipe lap-joint stub-end, so as to promote concentricity, centralization and equalized and uniform sealing force. The thumb is also slightly radially tapered (note the 2° angle “Ω” in FIG. 5) so that as the bolt-load increases, the tip of the thumb contacts the plastic polyethylene pipe stub-end very close to the pipe OD. The center-point of pressure occurs closer to the pipe OD, with the result being that the initial bolt-load is transferred to that point at first contact. As the bolt-load is increased by bolt-torque, the tip of the thumb indents the back face of the polyethylene pipe lap-joint stub-end by compressive load, initiating the sealing force on a circle almost adjacent to the pipe OD. As the bolt-load further increases, the thumb elastically bends and deforms and is brought into parallelism with the back end face 17 of the HDPE stub-end such that the center point of load remains closer to the pipe OD, versus the prior art designs. In the prior art designs, the flat “thumb” rotated out of parallelism, and the center-point of pressure moved outwardly towards the outer edge of the HDPE lap-joint stub-end, such that there was little sealing pressure on the ID of the HDPE lap-joint stub-end, and the majority of the bolt-load was concentrated towards the outer edge of the HDPE lap-joint stub-end. Applicant's improved bolt-ring design remedies these deficiencies.

Applicant's thumb portion, specifically that portion which is located radially innermost against the crotch of the lap-joint HDPE stub-end, may be limited in length by the bolt-pattern and the pipe OD. In such a case, the thumb can be provided as a sold mass joined to the inner vertical rim geometry. Alternately, when the bolt-pattern and pipe OD allow, the thumb portion can be provided with an increased length. In order to encourage uniform sealing pressure on the lap-joint HDPE stub-end, Applicant's design preferably uses a longer deformable thumb of variable cross-section that is more easily, uniformly and elastically deformed under bolt-load so as to apply uniform sealing pressure on the HDPE pipe stub-end.

Preferably, the bottom side 33 of one bolt-ring is contoured to mate with the top side 31 of a mating bolt-ring, whereby the bolt-rings are stackable for storage or shipment 8. The improved bolt-ring design thus incorporates a stacking feature such that when multiple rings are stacked and shipped, they “nest”, and thus resist horizontal sliding so as to remain in a stacked configuration. Typical prior art bolt-ring designs were subject to horizontal sliding when one or more of the prior art bolt-rings were being slid off of a stack of shipped rings. As a result, injuries to worker's legs and feet could occur more easily. While only one form of “nesting” features is illustrated in the drawings, those skilled in the art will appreciate that other convenient nesting designs could be utilized, as well.

The present invention provides a method for assembling the bolt-ring described above in order to connect the stub ends of two thermoplastic pipes, the pipes having an end stub with a contact shoulder and an oppositely arranged end face. With respect to the following discussion, “seating stress” and “sealing stress” define two separate, albeit closely related, stresses. “Seating stress” relates to the initial short-term bolt force applied to the bolt-ring when torquing the bolt-ring into place. “Sealing stress” relates to the long-term force distributed between the stub end faces of the two thermoplastic pipes that keep the pipe stub-ends appropriately connected and sealed, whereby the “sealing stress” is directly affected by the initial “seating stress” of the bolt-ring.

Note also that twisting bolt torque is given in foot-pounds. For example, in a case where a force of 100 pounds is applied over a two foot distance, the resulting bolt torque is 200 foot-pounds. In addition, bearing stress is defined in terms of a load over an area. The bolt torque stretches the bolt and bends the bolt-ring to create a load distributed over the flange face area, thus:
lbs/square inches=psi (stress)

The HDPE flanged joint, bolt-ring assembly of the invention is an engineered pressure containment connection, and is therefore subject to diverse forces. Although the HDPE bolt-ring assembly is simple in appearance, its design is complex due to the diverse forces that the assembly is exposed to over time. These forces might include, for example, axial shearing, radial dilation, disk-bending moments, residual interfacial sealing pressures, bolt-load versus bolt-torques, HDPE flange face creep-relaxation, bolt-ring flexure, axial tension from thermal contraction of the pipe-line, various vibrations, pressure-surges, pipe bendings due to soil settlement, etc. However, the greatest contributors to flange leakage are insufficient torque, un-even torque, and flange misalignment.

The ideal flange joint should exhibit compressibility, resilience, and creep-resistance. The HDPE flange face should be able to compress into any and all surface textures and imperfections of the mating flange. Also, the HDPE flange face should be sufficiently and elastically resilient to move with dynamic loadings to maintain seating stress. The flange face should exhibit sufficient creep-resistance so as not to permanently deform after bolt-up under varying load cycles of temperature and pressure.

One aspect of the method of the present invention is the fact that the “memory” of pipe-grade HDPE makes it an ideal flange face sealing surface. It becomes its own “gasket flange”, and seals well when un-marred and torqued to meet or exceed the HDPE seating stress. When properly torqued with the flexible bolt-ring of the invention, the HDPE flange adapter becomes self gasketing. HDPE flange adapters can be reliably self-sealing and self-gasketing, without leaks, when higher bolt-torque is applied so that the interfacial contact stress is above a restraint value for HDPE material. In this instance, the gasket (shown as 22 in FIG. 6) is not required, further distinguishing the principles of the present invention from the prior art.

More specifically, the method of the invention involves the discovery that the HDPE flange adapter self-gasketing “seating-stress” (generally shown by the upwardly pointing arrows in FIG. 8) is above a certain known value. This value for HDPE is preferably in the range above 1100 psi and less than 2200 psi. To reach this seating stress, both the use of a higher bolt torque, and the presence of a deformable bolt-ring are required, which combined factors compensate for visco-elastic cold flow of HDPE over time, and maintain a minimum threshold sealing stress.

There are several important aspects related to reaching the required seating stress, namely: (1) that the disk deformation of the bolt-ring applies continuous loading, (2) that it applies a high initial seating stress, (3) that it maintains an adequate sealing stress, and (4) that the percent deformation of the bolt-ring exceeds the percent visco-elastic cold flow of the HDPE over time so the assembly stage continues to provide an adequate seal.

The HDPE bolted flange assembly of the type under consideration can be evaluated as a combined mechanical “spring” assembly. The torqued bolts are elastically stretched to initiate the sealing pre-load. The metal bolt-ring is elastically flexed (bent by the bolt-load) to maintain the pre-load and transfer the load to the HDPE flange face. At small strains, the HDPE flange-face is elastically and visco-elastically deformed (by an axial compression and slight radial enlargement) so as to maintain pre-load sealing pressure on the flange-face surface. The HDPE flange face compressibility is the measure of its ability to deflect and conform to the mating flange face. This compressibility compensates for flange surface irregularities such as minor nicks, non-parallelism, metal corrosion, and variation in surface roughness or grooving depth. The HDPE flange face also exhibits memory/recovery/resiliency which are measures of the elasticity of the HDPE material to recover shape and to maintain its deformation sealing pressure under varying loads across broad temperature ranges. Although the HDPE is a visco-elastic material that slightly creeps over time, at sufficient torque the flexure of the bolt-ring and bolt stretch exceed the expected long-term compressive creep of the flange face, such that the residual sealing force exceeds the sum of the operating separation forces. In this way, the sealing pressure is maintained.

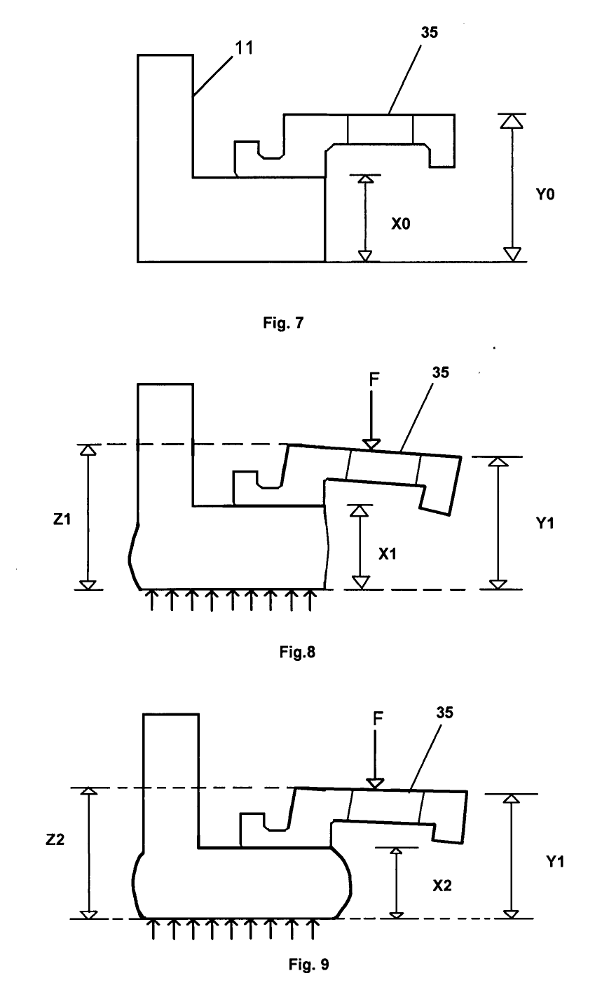

Turning to FIGS. 7-9, there is shown, in somewhat schematic fashion, an illustration of the method of the invention, as described above. FIG. 7, similarly to FIGS. 5 and 6, illustrates the initial assembly, as a partial cross-sectional view of the flange adapter and bolt-ring of the invention, specifying regions X₀ and Y₀. The bolt-rings use a truncated horizontal “S” shape to elastically deform and store that deformation strain so as to constantly load the visco-elastic flange faces.

FIG. 8 shows the elastically bent bolt-ring (flexure) and the initial compression of the viscoelastic flange face, illustrated as X₁. Y₁ is a fixed distance determined at initial bolt-up torque.

FIG. 9 illustrates the effects of the bolt-ring flexing and also the beginning stages of HDPE creep on the viscoelastic flange face (flange adapter). In other words, region X₂ moves down (X₂<X₁) as the effects of HDPE creep take effect (due to the flange face visco-elastically relaxing to the high seating stress) and the HDPE becomes further compressed in response to the seating stress. In response, however, the bolt-ring continues to provide sealing stress to the adapter. As also shown in FIG. 9 (Z₂<Z₁, but Y₁ remains the same fixed distance in comparison to FIG. 8). It should be noted that:
((Y0−Y1)>(X1−X2)).

By providing a sufficiently high seating stress to the bolt-ring, the thumb portion of the bolt-ring remains in contact with the HDPE flange adapter, even once HDPE creep effects have begun, to continually provide sealing stress and overcome the expected 50 year flange face visco-elastic strain at its relatively low sealing stress. The combined “springs” of the stretched bolts, the flexed disc bolt-ring, and the elastic component of the compressed flange-face, all serve to provide an elastic/visco-elastic, resilient “spring-seal” of the hydrostatically pressurized joint.

A key feature of the method of the present invention is the realization that, to achieve an effective sealing HDPE flange joint, the bolts must be torqued a predetermined amount (in effect “over-torquing” the bolts) to a sufficiently high value to stretch the bolts, so that the bolt-ring is flexurally-distorted, and the HDPE flange-face sufficiently and continuously compressed. The joint is at equilibrium, with the compressive sealing force distributed across the sealing face and equal in magnitude to the pre-tension in the bolts. The total bolt tension must be able to constrain the joint assembly against operating pressure, surge pressure, pipe-line axial thermal contraction, pipe bending strain from soil settlement, and flange angular alignment; all applied with a safety factor.

Three compression tests, each with differing compression speeds, were performed by Independent Pipe Products, Inc. of Dallas, Tex. Each test was performed to evaluate the reaction of a slowly compressed flange face ring. The test results would be analyzed to provide a predetermined range of appropriate bolt torques to be applied to the connection bolts when forming a connection between a pair of thermoplastic pipes. Flange rings have 4 to 44 bolts depending upon diameter, with an average 12″ bolt-ring having 12 bolts. Spending one minute per bolt to torque it up would give a compression rate to specified torque at 12 minutes for the whole flange face. This was shortened to 10 minutes. The flange ring was tested because a ring deforms differently from the standard compression test cylinder. The following discussion describes the results and analysis of the three compression tests.

Compression Test #1

The flange face ring was compressed 0.068″ over 10 minutes, which is a 6.8% strain. The load was curvilinear, with the max load being 3733 psi at the termination time of 10 minutes. HDPE did not fail in compression, it displaced. The ring flattened and the wall thickened (as seen in FIGS. 8 and 9 of the drawings). The outer diameter (OD) grew but the inner diameter (ID) shrank very little. At compression termination, the frame was dropped, and the ring underwent an immediate elastic recovery. As quickly as could be done there-after, the ring was measured with a calibrated digital micrometer, providing the measurement data seen in Table 1 below.

TABLE 1
Measured Dimensions of Compression Test #1

| | | | Measured Dimensions | | 4 Hour Recovered | | | |
|---|---|---|---|---|---|---|---|---|
| | Start | | at 6.8% Compression | | Dimensions | | 24 Hour Dimensions | |
| OD | 4.754″ | | 4.876″ | | 4.766″ | | 4.758″ | |
| Wall | 1.000″ | | 1.051″ | | 1.018″ | | 1.012″ | |
| ID | 2.754″ | | 2.774″ | | 2.750″ | | 2.734″ | |
| Volume | 11.8996 | in³ | 11.884 | in³ | 11.879 | in³ | 11.885 | cu-in |
| Thickness % | Zero | | 6.8% | | 1.8% | | 1.1% | |
| Compression | | | | | | | | |
| Facial Area | 11.78 | sq-in | 12.630 | sq-in | 11.90 | sq-in | 11.91 | sq-in |

| | | | | |
|---|---|---|---|---|
| Load in Lbs | — | 44,000 | lbs | — |
| Theoretical | — | 3735 | psi | — |
| Compressive Stress | | | | |
| True Compressive | — | 3484 | psi | — |
| Stress | | | | |

The immediate elastic “thickness recovery” upon sudden decompression was about 3.2%. The final dimensions suffered less than 1% permanent deformation in any direction, thus indicating that HDPE is still elastic at less than 7% compression, for a short compression time. Because the inner diameter essentially remained constant, the compression was driven into ring tension as an expanded outer diameter. The outer diameter elastic strain is hoop-tensioned, driven by facial compression. At fixed strain, the facial compressive stress is in equilibrium with the face's hoop-tension. Upon removal of facial compression, the hoop tension in the stretched molecules “spring” back, giving virtual elastic recovery to the original (outer diameter)×(wall)×(thickness).

TABLE 2
Stress and Strain Measurements During Compression Test #1

| | Time (minutes) | | | | | | | | | | | | |
|---|---|---|---|---|---|---|---|---|---|---|---|---|---|
| | zero | 1.25 | | 2.5 | | 3.75 | | 5.0 | | 7.5 | | 10.0 | |
| Approximate | zero | 1350 | psi | 2350 | psi | 2925 | psi | 3250 | psi | 3600 | psi | 3733 | psi |
| Compression | | | | | | | | | | | | | |
| Stress | | | | | | | | | | | | | |
| Compression | zero | 0.0085″ | | 0.017″ | | 0.025″ | | 0.034″ | | 0.051″ | | 0.068″ | |
| Strain | | | | | | | | | | | | | |
| % Compression | zero | 0.85% | | 1.7% | | 2.5% | | 3.4% | | 5.1% | | 6.8% | |
| Strain | | | | | | | | | | | | | |
| Apparent | zero | 162 | ksi | 138 | ksi | 117 | ksi | 96 | ksi | 71 | ksi | 55 | ksi |
| Compression | | | | | | | | | | | | | |
| Modulus | | | | | | | | | | | | | |

Compression Test #2

The flange face ring was compressed 0.0106″ over 10 minutes. This is a 10.6% strain. The load was curvilinear, with the max load being 3800 psi at the termination time of 11 minutes. HDPE does not fail in compression, it displaces. The ring flattened. The wall thickened. The diameter grew but the ID shrank very little. At compression termination, the frame was dropped, and the ring underwent an immediate elastic recovery. As quickly as could be done there-after, the ring was measured with a calibrated digital micrometer, providing the data seen in Table 3 below.

TABLE 3
Measured Dimensions of Compression Test #2

| | | | Measured Dimensions | | | | | |
|---|---|---|---|---|---|---|---|---|
| | | | at 10.5% | | | | 24 Hour Recovered | |
| | Start | | Compression | | 5 Minute Dimensions | | Dimensions | |
| OD | 4.762″ | | 4.848″ | | 4.796″ | | 4.762″ | |
| Wall | 1.008″ | | 1.129″ | | 1.025″ | | 1.013″ | |
| ID | 2.746″ | | 2.728″ | | 2.746″ | | 2.736″ | |
| Volume | 11.841 | in³ | 11.845 | in³ | 11.839 | in³ | 11.847 | cu-in |
| Thickness % | Zero | | 10.5% | | 2.9% | | 1.1% | |
| Compression | | | | | | | | |
| Facial Area | 11.888 | sq-in | 13.191 | sq-in | 12.143 | sq-in | 11.931 | sq-in |

| | | | | |
|---|---|---|---|---|
| Load in Lbs | — | 44,000 | lbs | — |
| Theoretical | — | 3800 | psi | — |
| Compressive Stress | | | | |
| True Compressive | — | 3411 | psi | — |
| Stress | | | | |

Upon release after 10 minutes of compression, the ring exhibits fast elastic recovery. The final dimension suffered less than 1% permanent deformation, thus indicating that HDPE is still elastic at less than 10% compression, for a short compression time. Because the inner diameter essentially remained constant, the compression was driven into ring tension as an expanded outer diameter. The outer diameter elastic strain is hoop-tensioned, driven by facial compression. At fixed strain, the facial compressive stress is in equilibrium with the face's hoop-tension. Upon removal of facial compression, the hoop tension in the stretched molecules “spring” back, giving virtual elastic recovery to the original (outer diameter)×(wall)×(thickness).

TABLE 4
Stress and Strain Measured During Compression Test #2

| | Time (minutes) | | | | | | |
|---|---|---|---|---|---|---|---|
| | zero | 1.25 | 2.5 | 3.75 | 5.0 | 7.5 | 10.0 |
| Approximate | zero | 1075 psi | 2000 psi | 2580 psi | 3000 psi | 3500 psi | 3725 psi |
| Compression | | | | | | | |
| Stress | | | | | | | |
| Compression | zero | 0.013″ | 0.0265″ | 0.040″ | 0.053″ | 0.079″ | 0.106″ |
| Strain | | | | | | | |
| % Compression | zero | 1.3% | 2.6% | 4.0% | 5.3% | 7.9% | 10.6% |
| Strain | | | | | | | |

Compression Test #3

The flange face ring was compressed 0.0112″ over 10 minutes. This is a 11.2% strain. The load was curvilinear, with the max load being 3733 psi at the termination time of 10 minutes. HDPE does not fail in compression, it displaces. The ring flattened and the wall thickened. The diameter grew but the inner diameter shrank very little. At compression termination, the frame was dropped, and the ring underwent an immediate elastic recovery. As quickly as could be done there-after, the ring was measured with a calibrated digital micrometer, wherein the data attained is shown in Table 5 below.

TABLE 5
Measured Dimensions of Compression Test #3

| | | | Measured Dimensions | | 4 Hour Recovered | | | |
|---|---|---|---|---|---|---|---|---|
| | Start | | at 6.8% Compression | | Dimensions | | 24 Hour Dimensions | |
| OD | 4.756″ | | 4.870″ | | 4.80″ | | 4.753″ | |
| Wall | 1.002″ | | 1.134″ | | 1.033″ | | 1.012″ | |
| ID | 2.72″ | | 2.602″ | | 2.734″ | | 2.729″ | |
| Volume | 11.864 | in³ | 11.871 | in³ | 11.879 | in³ | 11.834 | cu-in |
| Thickness % | Zero | | 11.2% | | 2.6% | | 1.0% | |
| Compression | | | | | | | | |
| Facial Area | 11.817 | sq-in | 13.310 | sq-in | 12.225 | sq-in | 11.894 | sq-in |

| | | | | |
|---|---|---|---|---|
| Load in Lbs | — | 45,050 | lbs | — |
| Theoretical | — | 3811 | psi | — |
| Compressive Stress | | | | |
| True Compressive | — | 2863 | psi | — |
| Stress | | | | |

The immediate elastic “thickness recovery” upon sudden decompression was over 8%. The final dimensions suffered less than 1% permanent deformation in any direction, thus indicating that HDPE is still elastic at less than 11% compression, for a short compression time. At higher compression, more of the flattening was driven into inner diameter contraction. The outer diameter elastic strain is hoop-tensioned, driven by facial compression. At fixed strain, the facial compressive stress is in equilibrium with the face's hoop-tension. Upon removal of facial compression, the outer diameter hoop tension in the stretched molecules contract, giving virtual elastic recovery to the original (outer diameter)×(wall)×(thickness). The inner diameter molecules are compressed, and elongate upon release of load, giving high elastic recovery.

TABLE 6
Stress and Strain Measured During Compression Test #3

| | Time (minutes) | | | | | | | | | | | | |
|---|---|---|---|---|---|---|---|---|---|---|---|---|---|
| | zero | 1.25 | | 2.5 | | 3.75 | | 5.0 | | 7.5 | | 10.0 | |
| Approximate | zero | 1125 | psi | 2000 | psi | 2600 | psi | 2975 | psi | 3500 | psi | 3700 | psi |
| Compression | | | | | | | | | | | | | |
| Stress | | | | | | | | | | | | | |
| Compression | zero | 0.014″ | | 0.028″ | | 0.042″ | | 0.056″ | | 0.084″ | | 0.112″ | |
| Strain | | | | | | | | | | | | | |
| % Compression | zero | 1.4% | | 2.8% | | 4.2% | | 5.6% | | 8.4% | | 11.2% | |
| Strain | | | | | | | | | | | | | |
| Apparent | zero | 81 | ksi | 71 | ksi | 62 | ksi | 53 | ksi | 42 | ksi | 33 | ksi |
| Compression | | | | | | | | | | | | | |
| Modulus | | | | | | | | | | | | | |

In conclusion, based upon the results of the three compression test results, the use of 1100 psi to 2200 psi as a seating stress range is a practical range for accomplishing the objectives of the method of the invention. This seating stress allows the flex of the “S” shape bolt-ring to overcome the flange face visco-elastic relaxation in response to HDPE creep over time, and provide a continual sealing stress to the pipe connection.

After determining the desired seating stress as outlined above, the specific method steps which are utilized in the practice of the present invention begin with the step of sliding the mating bolt-rings into contact on the respective stub ends of the pipe to be connected. Next, the mating bolt-rings are connected by bolting the rings together with connecting bolts. The connecting bolts pass through the spaced bolt holes provided in the web portion of each bolt-ring. The bolts are torqued by an amount sufficient to elastically deform the mating bolt-rings and thereby create a deformation strain. The deformation strain is stored in the bolt-rings by the applied torque so as to constantly load the visco-elastic flange faces of the pipe stub ends. More specifically, the bolts are torqued by a predetermined amount, such that after seating at a given seating stress, the respective flange face visco-elastically relaxes to a relatively high sealing stress, and that subsequent naturally occurring flexing of the “S” shape bolt-ring has sufficient distortion to overcome an expected 50 year flange face oppositely directed visco-elastic strain at the relatively lower sealing stress. The bolt torque is applied within a predetermined range which compensates for visco-elastic cold flow of HDPE over time, and maintains a minimum threshold sealing stress In the preferred embodiment of the invention, the applied bolt torque develops the seating stress within the range of 1100 psi and 2200 psi distributed over the stub end face. When a seating stress within the range of 1100 psi and 2200 psi is applied, the HDPE stub-end becomes “self gasketing”, meaning that the gasket, illustrated as 22 in FIG. 6, is not required.

An invention has been provided with several advantages. The improved bolt-ring of the invention is specifically designed to be used with Van-Stone style lap-joint HDPE stub end pipe. The improved bolt-rings are lighter in weight and more economical to produce. The variable cross sectional geometry of the design provides a predetermined and predictable deformation of the bolt-ring under working loads. The result is more uniform and predictable load distribution on the end faces of the pipe stub end. The controlled deformation also imposes a spring load on the pipe stub end which accommodates thermal strain in the polyethylene material of the pipe. The result is a more reliable sealing joint for HDPE stub end pipe. In addition, the improved method of the present invention provides the application of a bolt torque to establish the initial seating stress within a predetermined range (e.g., between 1100 psi and 2200 psi) in order to compensate for visco-elastic cold flow of HDPE over time, and maintain a minimum threshold sealing stress. There are other advantages of the invention discussed above with respect to the various details of the design and which will be appreciated by those skilled in the relevant art.

While the invention has been shown in only one of its forms, it is not thus limited but is susceptible to various changes and modifications without departing from the spirit thereof.

What is claimed is:

1. A method of forming a connection between a pair of oppositely arranged stub end thermoplastic pies, each pipe having an end stub with a contact shoulder and an oppositely arranged end face separated by a thickness which constitutes a visco-elastic flange adapter face, the method comprising the steps of:
providing a pair of mating bolt-rings on the stub ends of the oppositely arranged pipes, each bolt-ring comprising a bolt-ring body having an outer vertical rim portion, an inner vertical rim portion and a web portion interconnecting the outer vertical rim portion and the inner vertical rim portion, the web portion having a plurality of spaced bolt holes therein which circumscribe a centerline of the bolt-ring body;
wherein the inner vertical rim portion, outer vertical rim portion and interconnecting web portion together form a bolting-face for each bolt-ring on a top side thereof, the top side of each bolt-ring having a beveled and angular top surface, and wherein an opposite bottom side of each bolt-ring includes a contoured recess that reduces the material of the bolt-ring body and provides a variable cross sectional geometry;
wherein the inner vertical rim portion includes a thumb region on the bottom side of the bolt-ring which contacts the contact shoulder of the pipe stub end in use;
sliding the mating bolt-rings into contract with a contact shoulder on the respective stub ends of the pipes to be connected;
connecting the mating bolt-rings by bolting the rings together with connecting bolts, the connecting bolts passing through the spaced bolt holes provided in the web portion of each bolt-ring; and
torquing the bolts by an amount sufficient to elastically deform the mating bolt-rings by a predetermined amount which thereby creates a deformation strain, the deformation strain being stored in the bolt-rings by the applied torque so as to constantly load the visco-elastic flange adapter faces of the pipe stub ends.

2. The method of claim 1, wherein each of the bolt-rings has a truncated horizontal “S” shape capable of being elastically deformed and of storing a resulting deformation strain so as to constantly load the visco-elastic flange faces of the pipe stub ends.

3. The method of claim 2, wherein the bolts used to connect the bolt-rings are torqued by a predetermined amount, such that after seating at a given seating stress, the respective flange faces visco-elastically relax to a relatively high sealing stress.

4. The method of claim 3, wherein a subsequent naturally occurring flexing of the “S” shape bolt-ring has sufficient distortion to overcome an expected 50 year flange face oppositely directed visco-elastic strain at a relatively lower sealing stress.

5. A method of forming a connection between a pair of oppositely arranged stub end thermoplastic pipes, each pipe having an end stub with a contact shoulder and an oppositely arranged end face, the method comprising the steps of:
providing a pair of mating bolt-rings on the stub ends of the oppositely arranged pipes, each bolt-ring comprising a bolt-ring body having an outer vertical rim portion, an inner vertical rim portion and a web portion interconnecting the outer vertical rim portion and the inner vertical rim portion, the web portion having a plurality of spaced bolt holes therein which circumscribe a centerline of the bolt-ring body;
wherein the inner vertical rim portion, outer vertical rim portion and interconnecting web portion together form a bolting-face for each bolt-ring on a top side thereof, the top side of each bolt-ring having a beveled and angular top surface, and wherein an opposite bottom side of each bolt-ring includes a contoured recess that reduces the material of the bolt-ring body and provides a variable cross sectional geometry;
wherein the inner vertical rim portion includes a thumb region on the bottom side of the bolt-ring which contacts the contact shoulder of the pipe end stub in use;
sliding the mating bolt-rings into contact on the respective stub ends of the pipe to be connected;
connecting the mating bolt-rings by bolting the rings together with connecting bolts, the connecting bolts passing through the spaced bolt holes provided in the web portion of each bolt-ring; and
applying a bolt torque within a predetermined range to deliver a seating stress which compensates for visco-elastic cold flow of HDPE over time, and maintains a minimum threshold sealing stress.

6. The method of claim 5, wherein an interfacial contact stress is determined for the connection and wherein the bolt torque applied to the mating bolt rings is selected so that the interfacial contact stress is above a certain value for HDPE.

7. The method of claim 6, wherein the applied seating stress is within the range of 1100 psi and 2200 psi.

8. The method of claim 5, wherein the thermoplastic pipes and stub ends are comprised of high density polyethylene (HDPE).

9. The method of claim 5, wherein the bolt rings are formed of metal.

10. The method of claim 9, wherein the bolt rings are formed of ductile iron.

11. The method of claim 7, wherein the application of a seating stress in the range of 1100 psi and 2200 psi allows the stub-ends to become self gasketing.
